(19) United States
(12) Patent Application Publication
(10) Pub. No.: US 2023/0370203 A1
(43) Pub. Date: Nov. 16, 2023

(54) SELECTIVE ACKNOWLEDGEMENT FRAMEWORK FOR HIGH-PERFORMANCE NETWORKS

(71) Applicant: Meta Platforms, Inc., Menlo Park, CA (US)

(72) Inventors: Arvind SRINIVASAN, San Jose, CA (US); Zeeshan Altaf LOKHANDWALA, Redwood City, CA (US); Pankaj KANSAL, Fremont, CA (US); Nicolaas Johannes VILJOEN, San Bruno, CA (US)

(73) Assignee: Meta Platforms, Inc., Menlo Park, CA (US)

(21) Appl. No.: 17/742,854

(22) Filed: May 12, 2022

(51) Int. Cl. H04L 1/18; H04L 1/16; H04L 5/00

(52) U.S. Cl. CPC H04L 1/1809; H04L 1/1628; H04L 1/1642; H04L 5/0055

(57) ABSTRACT

According to examples, a selective acknowledgement framework may be implemented within a communication system for efficient communication of acknowledgement packets. A plurality of data packets generated from a message may be transmitted as a segment of data packets to a receiver which generates an acknowledgement packet for the segment of data packets. A compact format of acknowledgement (ACK) or negative acknowledgement (NACK) for the segment of data packets may be implemented in the acknowledgement packet via bits of a selective acknowledgement bit vector. Based on the other values also conveyed in the acknowledgement packet, the transmitter may identify those data packets that were properly received and the data packets that need to be re-transmitted.

### TECHNICAL FIELD

This patent application relates generally to data generation and transfer, and more specifically, to a selective acknowledgement framework utilizing bit vector arrays to track the transmission and reception of data packets.

### BACKGROUND

In some examples, to enable bi-directional transit of data packets between network components, communication networks may use packet sequences or acknowledgement numbers to keep track of transferred data. However, only ideally and rarely are all of the data packets delivered to the network entities successfully and in order.

When one or more data packets are missed or lost during a transmission, a receiving entity may send a request for re-transmission to the transmitting entity. In some instances, the transmitting entity may respond with all of the data packets that were previously transmitted due to the network delay in receiving the acknowledgements from the receiving entity for successfully delivered data packets.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 shows a block diagram of a communication system that may implement a selective acknowledgement framework, according to an example.

FIG. 2 shows a diagram illustrating operation of different pointers and trackers that may be maintained by a transmitter and a receiver, according to an example.

FIG. 3 shows an illustration of a Packet Sequence Number (PSN) space, according to an example.

FIG. 4 shows a diagram illustrating interactions between various elements of a transmitter for tracking the transmission of data packets, according to an example.

FIG. 5 shows a diagram of the interactions between various elements of a receiver for tracking the reception of data packets, according to an example.

FIG. 6 shows a flowchart of the selective acknowledgement process implemented by the transmitter, according to an example.

FIG. 7 shows a flowchart of a method of implementing selective acknowledgement of data packets by the receiver, according to an example.

FIG. 8 shows the initial states of the various tables and pointers during a transmission, according to an example.

FIG. 8A shows state changes of different tables and pointers during a packet tracking process, according to an example.

FIG. 8B illustrates a re-transmission operation, according to an example.

FIG. 8C illustrates a transmission operation according to an example.

FIG. 9 illustrates a block diagram of a computer system for data packet transmission, reception, and acknowledgement, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

The use of selective acknowledgements to trigger retransmissions has been shown to improve over tail latency without needing to enable priority flow controls (PFC) for high-performance networks. However, in some instances, tracking packets that are lost on the network and conveying that information from the receiver back to the transmitter may be quite complex, especially when the network latencies may be quite large.

Generally, exact sequence numbers of lost data packets may be conveyed to a transmitter in the form of a negative acknowledgement (NACKs) or a selective acknowledgement (SACKs) where such sequence numbers are stacked. In some instances, this may add significant complexity to the implementation on both the transmitter and receiver sides.

In some examples, a selective acknowledgement framework implemented according to the examples described may eliminate complexities via the use of bit-vectors across the transmitter, receiver, and acknowledgement packets. In some examples, the examples described may implement a compact form of representing different combinations of acknowledgements (ACKs) and negative acknowledgements (NACKs) when multiple packet drops occur.

According to some examples, a transmitter may transmit a segment or a group of one or more data packets to a receiver, wherein each data packet of the one or more data packets may be identified via a corresponding packet sequence number (PSN). The transmitter may include a transmission tracker having one or more transmit bit vector arrays that may store bit vector representations of the packet sequence numbers (PSNs) of the data packets.

In some examples, the transmitter may maintain at least two pointers. In some examples, a first pointer of the two pointers may include at least a highest scheduled packet sequence number (PSN) pointer that may store the packet sequence number (PSN) of the data packet from the segment of data packets scheduled for the next transmission. In some examples, a second pointer of the two pointers may include a contiguously acknowledged packet sequence number (PSN) pointer that stores a packet sequence number (PSN) of a last data packet of a sequence of data packets that may be acknowledged by the receiver as contiguously received from the segment of data packets so that no retransmission may be needed. In some examples, the last data packet may be identified in terms of the sequence of packet sequence numbers (PSNs) rather than a temporal sequence. The difference between the packet sequence numbers (PSNs) of the pointers may correspond to the packet sequence numbers (PSNs) of the in-flight data packets that may have been ejected from the transmitter but are yet to arrive at the receiver.

In some examples, a receiver that may receive the segment of data packets from the transmitter may also maintain a receiver tracker including one or more receive bit vector arrays. In some examples, the receiver tracker may be utilized to store bit vector representations of the packet sequence numbers (PSNs) of the data packets received from a segment of data packets. The size of each of the transmission tracker and the receiver tracker may be a variable of the Bandwidth Delay Product (BDP) of the network to accommodate all the in-flight data packets which may require tracking. The receiver may also maintain at least two pointers that may be based on the receiver tracker as well. In some examples, the at least two pointers may include a contiguously received packet sequence (PSN) pointer that may store the packet sequence number (PSN) of a last data packet of a sequence of data packets contiguously received from the segment of data packets. It may be appreciated that, in some examples, the last data packet may be identified based on the packet sequence number (PSN) sequence rather than a temporal order in which a data packet may be received. In addition, in some examples, a second pointer may include a highest received packet sequence number (PSN) pointer storing a packet sequence number (PSN) of a last data packet successfully received from the segment of data packets. Again, in some examples, a difference in the packet sequence numbers (PSNs) of the two pointers maintained by the receiver may correspond to the packet sequence numbers (PSNs) of the in-flight data packets.

In some examples, a receiver may generate an acknowledgement packet from values stored in a receiver tracker. In some examples, the acknowledgement packet may include at least a select acknowledgement bit vector, wherein each bit of the select acknowledgement bit vector may represent a corresponding data packet of a segment of data packets. Additionally, a value of each bit of the select acknowledgement bit vector may indicate an acknowledgement (ACK) or negative acknowledgement (NACK) of the corresponding data packet.

In order to enable a transmitter to identify corresponding data packets, an acknowledgement packet may also include a last contiguously acknowledged sequence number as an anchor value from where a select acknowledgement bit vector may be applicable. In some examples, the acknowledgement packet may also include a maximum sequence number that may represent a number of the packet sequence numbers (PSNs) being acknowledged as well. Furthermore, optionally, the acknowledgement packet may include an optional parameter of chained acknowledgements if there may be a series of acknowledgement packets for one segment of data packets.

Upon receipt of an acknowledgement packet by a transmitter, various values may be extracted and an update operation may be executed to update a transmission tracker for an identification of acknowledgements (ACKs) and/or the negative acknowledgements (NACKs) corresponding to a segment of data packets. For example, the update may include an exclusive OR operation between the select acknowledgement bit vector and one or more of the transmit bit vector arrays to eliminate data packets with duplicate acknowledgements. In some examples, the data packets associated with the negative acknowledgements (NACKs) may be re-transmitted upon updating the transmission tracker. In some examples, the transmitter may be configured with one or more timers that may sweep the transmit bit vector arrays so that upon timeout, the data packets associated with negative acknowledgements (NACKs) may be automatically re-transmitted.

In some examples, a selective acknowledgement scheme described above may mitigate the need for the transmitter and the receiver to exchange the complete packet sequence numbers (PSNs) of the data packets as each data packet may be represented by a bit in the select acknowledgement bit vector. In some examples, a combination of a last contiguously acknowledged sequence number as an anchor value and a maximum sequence number may enable a network entity to accurately identify the data packets that may be referred to within the acknowledgement packet. In some examples, such a compact communication scheme may improve the efficiency of the network while reducing latency and conserving network resources as it may mitigate a need for exchanging all packet sequence numbers (PSNs) of data packets that may be acknowledged or negative acknowledged.

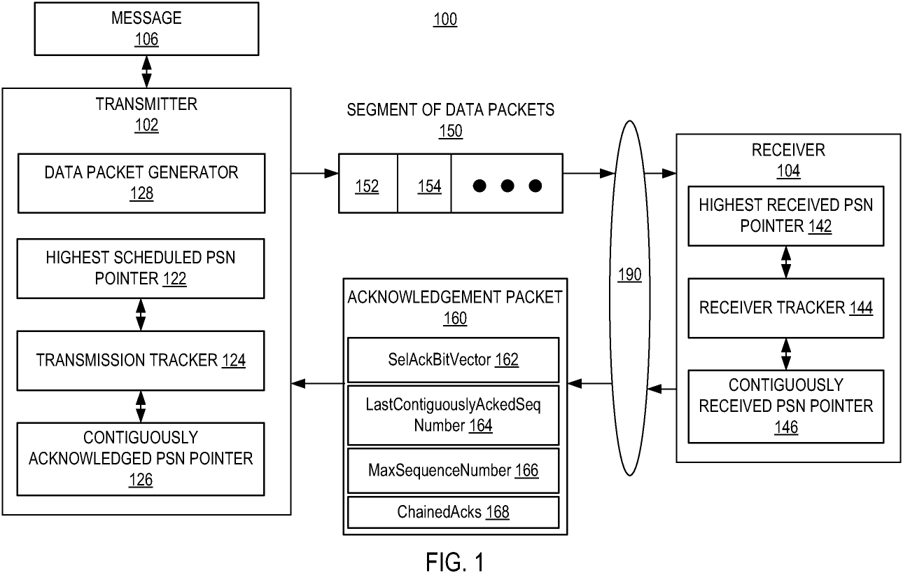

FIG. 1 shows a block diagram of a communication system 100 that may implement a selective acknowledgement framework, according to an example. In some examples, the system 100 may include a transmitter 102 that may transmit data packets to a receiver 104 via a communication network 190. When a message 106 is received for transmission, a data packet generator 128 may segment the message 106 to generate one or more data packets. The message 106 may be of any size and the data packet generator 128 segments the message 106 based on the maximum transmission unit (MTU) - a measurement representing the largest data packet that a network-connected device may accept. It may be noted that MTU can take a value provided by a network administrator. Accordingly, in some examples, a plurality of MTU-sized data packets 152, 154, ....may be transmitted as a segment of data packets 150. It may be noted that although it is described herein that all the data packets 152, 154, ... included in the segment of data packets 150 are obtained from segmenting a single message i.e., the message 106, this is for simplification of the description only and that this is not necessary. A single segment of data packets may carry data packets generated from multiple messages. Conversely, if a message is large enough, then the data packets of such a large message may be transmitted in multiple segments. The compact form of acknowledgement scheme disclosed herein may also be implemented in the different situations described above.

In some examples, a number of data packets in the segment of data packets 150 may be a configurable quantity within the network 190. In particular, the configurable quantity may be based on various factors, including but not limited to a capacity of the transmitter 102, a capacity of the receiver 104, a network bandwidth, etc. Moreover, each data packet 152, 154, ... of the segment of data packets 150 may be uniquely identified by a corresponding packet sequence number (PSN).

In some examples, corresponding packet sequence numbers (PSNs) of the plurality of data packets e.g., 152, 154, ... may be in sequential order. In an example, the packet sequence numbers (PSNs) of the segment of data packets 150 may be maintained within the transmitter 102 in one or more transmit bit vector arrays that may form a transmission tracker 124. As the data packets are received by the receiver 104, the receiver 104 may transmit acknowledgements (ACKs) for each data packet received correctly and negative acknowledgements (NACKs) for data packets that may include errors or were never received.

The receiver 104 may transmit one acknowledgement packet for a given segment of data packets received in a data stream. For example, one acknowledgement packet 160 may be transmitted for the segment of data packets 150. The acknowledgement packet 160 may include at least three fields, viz., a select acknowledgement bit vector (SelAckBitVector) 162, a last contiguously acknowledged sequence number (LastContiguouslyAckedSeqNumber) 164 and a maximum sequence number (MaxSequenceNumber) 166. In an example, the acknowledgement packet 160 may also include an additional field of ChainedAcks 168, wherein a flag which when set may represent that a total acknowledgement for the segment of data packets 150 may be sent over multiple acknowledgement packets.

In some examples, a data packet (e.g., data packet 152 of the segment of data packets 150) may be represented by a bit in the SelAckBitVector 162. Furthermore, in some examples, a value of each bit of the SelAckBitVector 162 may represent one of an acknowledgement (ACK) or a negative acknowledgement (NACK) of the corresponding data packet of the segment of data packets 150. In an example, the transmitter 102 may be configured with a predetermined timeout so that if neither an acknowledgement (ACK) nor a negative acknowledgement (NACK) is received from the receiver 104 for a data packet, such a data packet may be automatically retransmitted after the timeout. Furthermore, information regarding the data packets may be exchanged between the transmitter 102 and the receiver 104 in a more compact form that may include bit vector representations of a plurality of packet sequence numbers (PSNs). Accordingly, in some examples, the acknowledgement packet 160 may include the LastContiguouslyAckedSeqNumber 164 that may represent an anchor value in the sequence number space from where the SelAckBitVector 162 may be applicable. In addition, in some examples, the MaxSequenceNumber 166 may represent a number of packet sequence numbers (PSNs) being acknowledged in the acknowledgement packet 160 based on the data packets that may be received by the receiver 104. In particular, since the receiver 104 may lag the transmitter 102 due to the latency in the network 190, the MaxSequenceNumber 166 field may prevent retransmission of data packets that may still be in flight and may yet reach the receiver 104.

In order to decode the compact acknowledgement format implemented by the acknowledgement packet 160, the transmitter 102 and the receiver 104 maintain certain pointers for storing certain values that may be changed dynamically as needed during the data communication. In an example, the transmitter 102 may maintain within the transmission tracker 124, an increasing number representing new data packets that are transmitted. A highest scheduled packet sequence number (PSN) pointer 122 may store a monotonically increasing number representing a new entry that may be created in the transmission tracker 124 if space is available. In case there is no space available in the transmission tracker 124 due to backpressure, the data packets may be held back from transmission until the space is available in the transmission tracker 124. In some examples, the transmission tracker 124 may include one or more transmit bit vector arrays that may store bit vector representations of packet sequence numbers (PSNs) of data packets that were sent to the receiver 104. Accordingly, in some examples, the size of the transmission tracker 124 may equal the number of data packets of maximum transmission unit (MTU) size possible within the Bandwidth Delay Product (BDP) of the network. In some examples, the transmitter 102 may also maintain a contiguously acknowledged packet sequence number (PSN) pointer 126 that may store the packet sequence number (PSN) of the latest data packet of a sequence of data packets that may be contiguously transmitted from the segment of data packets 150 and that may require no retransmission. In some examples, the application software within the transmitter 102 may use the contiguously acknowledged packet sequence number (PSN) pointer 126 to free up and to reuse the packet data memory. In an example, the communication system 100 may also generate completion updates to the software based on the highest scheduled packet sequence number (PSN) pointer 122 and the contiguously acknowledged packet sequence number (PSN) pointer 126. In some instances, a difference between the highest scheduled PSN pointer 122 and the contiguously acknowledged packet sequence number (PSN) pointer 126 may correspond to the amount of inflight data.

In some examples, the receiver 104 may also maintain a plurality of pointers. In some examples, the receiver 104 may include a highest received packet sequence number (PSN) pointer 142 and a contiguously received packet sequence number (PSN) pointer 146. In some examples, the highest received packet sequence number (PSN) pointer 142 may store a number representing the highest packet sequence number (PSN) number of the data packet received successfully by the receiver 104. In some examples, a new entry may be created in a receiver tracker 144 if space may be available. In some examples, where no space may be available in the receiver tracker 144 to store the packet sequence number (PSN) of a received data packet, then such a data packet may be dropped by the receiver 104. In these examples, this may be considered an error scenario as it may represent an out-of-range packet reception wherein the transmission rate of the data packets may exceed the tracking capacity of the receiver 104.

The receiver 104, may periodically acknowledge the received data packets. The contiguously received packet sequence number (PSN) pointer 146 may store the packet sequence number (PSN) of the last data packet of a sequence of data packets contiguously received with no drops (including post-retransmission) from the segment of data packets 150. Again, the applications software on the receiver side may use the contiguously received packet sequence number (PSN) pointer 146 to pass on the received data to the upper-level software stack. Transport engines may also generate completion updates based on these two pointers. The difference between the highest received packet sequence number (PSN) pointer 142 and the contiguously received packet sequence number (PSN) pointer 146 corresponds to the amount of inflight data. Any data successfully received in this range by the receiver 104 may be written into the memory of the receiver 104 directly and tracked as part of the receiver tracker 144. The size of the receiver tracker 144 may equal the number of Maximum Transmission Unit (MTU) packets possible within the Bandwidth Delay Product (BDP) of the communication network 190.

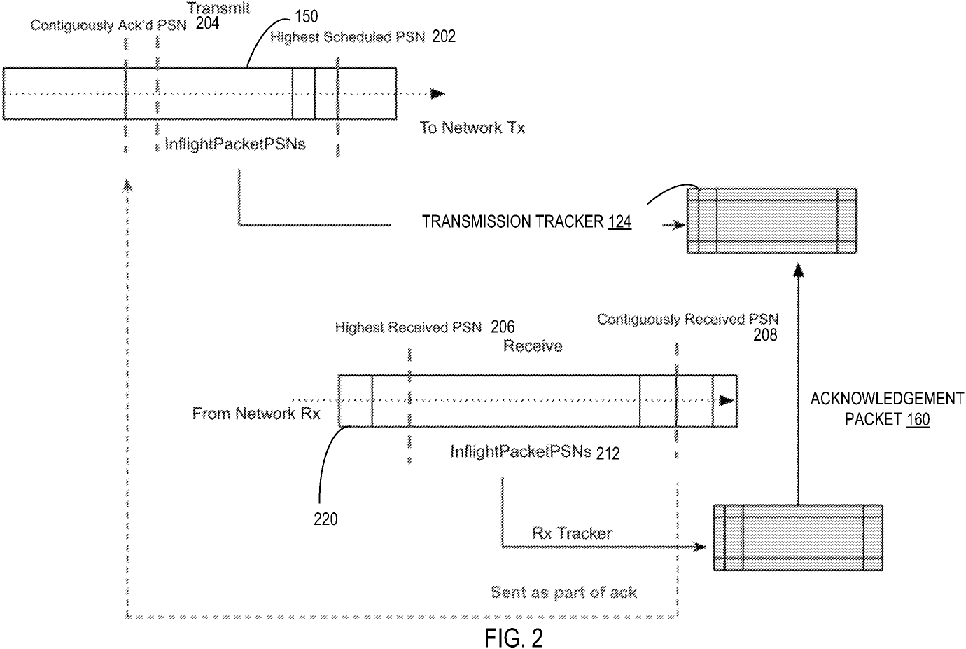

FIG. 2 shows a diagram illustrating operation of different pointers and trackers that may be maintained by the transmitter 102 and the receiver 104, according to an example. The highest scheduled packet sequence number (PSN) pointer 122 maintained by the transmitter 102 may store the highest scheduled packet sequence number (PSN) 202. The receiver 104 may also maintain in the highest received packet sequence number (PSN) pointer 142 a highest received packet sequence number (PSN) 206 i.e., the packet sequence number (PSN) of the data packet that was last received. As the transmitter 102 and the receiver 104 implement a selective acknowledgement scheme for the data packets wherein a single acknowledgement packet may be used to provide the acknowledgements (ACKs) or negative acknowledgements (NACKs) of multiple data packets, the pointers may be used to store the reference values for identifying the data packets while an abbreviated form of data packet identification may be exchanged between the transmitter 102 and the receiver 104. Accordingly, when a data packet from the segment of data packets 150 is transmitted to the receiver 104, the packet sequence number (PSN) of the data packet may be stored in the transmission tracker 124 and the value of the highest scheduled packet sequence number (PSN) 202 (which may be stored in the highest scheduled packet sequence number (PSN) pointer 122) may be incremented.

The data packets 220 may represent one or more data packets of the segment of data packets 150 that are transmitted to the receiver 104. The receiver 104 may generate an acknowledgement (ACK) or a negative acknowledgement (NACK) message for each of the data packets 220. As the data packet from the transmitter 102 is received at the receiver 104, the packet sequence number (PSN) of the received data packet may be stored in the receiver tracker 144 and the value of the highest received packet sequence number (PSN) 206 may be incremented. In an example, the currently updated packet sequence number (PSN) of the receiver tracker 144 can be compared to the packet sequence number (PSN) of the previously stored data packet and if it is determined that the packet sequence numbers (PSNs) of the current data packet and the prior data packet are consecutive, then the contiguously received packet sequence number (PSN) 208 may be incremented and the bit corresponding to the data packet in the SelAckBitVector 162 may be set to indicate an acknowledgement. Additionally, it may be determined if the acknowledgement packet 160 is to be generated. In an example, the acknowledgement packet 160 may be generated when a predetermined number of data packets are received by the receiver 104 or the acknowledgement packet 160 may be generated upon the expiration of a predetermined time (e.g., timeout). The SelAckBitVector 162 may be generated by including bits representing an acknowledgement (ACK) (e.g., ‘1’) or a negative acknowledgement (NACK)(e.g., ‘0’) for each received data packet. The value of the contiguously received packet sequence number (PSN) pointer 146 may be included as LastContiguouslyAckedSeqNumber 164 in the acknowledgement packet 160. The number of data packets or packet sequence numbers (PSNs) being acknowledged in the acknowledgement packet 160 may be included as MaxSequenceNumber 166 and optionally, if more than one acknowledgement packet is being transmitted, the ChainedAcks 168 flag may be set. The acknowledgement packet 160 thus generated may be provided to the transmitter 102.

Upon receiving the acknowledgement packet 160, the transmitter 102 may extract the LastContiguouslyAckedSeqNumber 164 to identify the data packet that was last received contiguously by the receiver 104 and may update the value of the contiguously acknowledged packet sequence number (PSN) 204 stored in the contiguously acknowledged packet sequence number (PSN) pointer 126. The packet sequence numbers (PSNs) s of the data packets associated with the bits in the SelAckBitVector 162 may be counted from the LastContiguouslyAckedSeqNumber 164 until the MaxSequenceNumber 166. Therefore, the last contiguously acknowledged sequence number (i.e., LastContiguouslyAckedSeqNumber 164) forms an anchor value in a sequence number space from where the select acknowledgement bit vector (i.e., SelAckBitVector 162) may be applied. The difference between the highest scheduled packet sequence number (PSN) pointer 122 and the contiguously acknowledged packet sequence number (PSN) pointer 126 may be identified as data packets in flight between the transmitter 102 and the receiver 104. The packet sequence numbers (PSNs) of the in-flight packets may be tracked using the transmission tracker 124. Similarly, the difference between the highest received packet sequence number (PSN) 206 and the contiguously received packet sequence number (PSN) 208 correspond to the inflightPacketPSNs 212 of either dropped packets that were never received or data packets that are in-flight from the transmitter 102 that are yet to be received by the receiver 104.

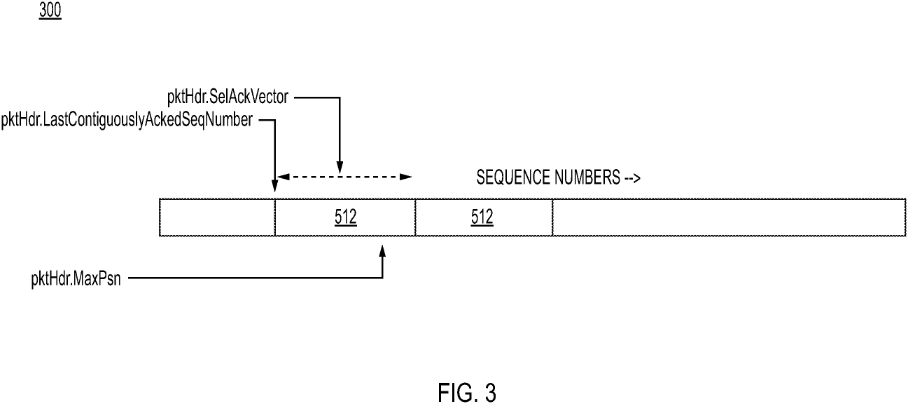

FIG. 3 shows an illustration of a Packet Sequence Number (PSN) space 300, according to an example. In this example, it is assumed that each segment of data packets includes 512 data packets and the various fields of the acknowledgement packet 160 are shown relative to the packet sequence number (PSN) space. By way of illustration and not limitation, the SelAckVector 162 in the acknowledgement packet header may include 512 bits. The acknowledgement packet header may also include the LastContiguouslyAckedSeqNumber 164 and the MaxSequenceNumber 166. There may be more than one acknowledgement packet outstanding in the network for acknowledging different segments in the above sequence number space. Architecturally there may be no limits on how many data packets can be acknowledged as multiple acknowledgement packets may be chained using the ChainedAcks 168 flag in the acknowledgement packet headers. In an example, the number of data packets acknowledged in a single acknowledgement packet may only be limited by the size of the tracking supported in the hardware.

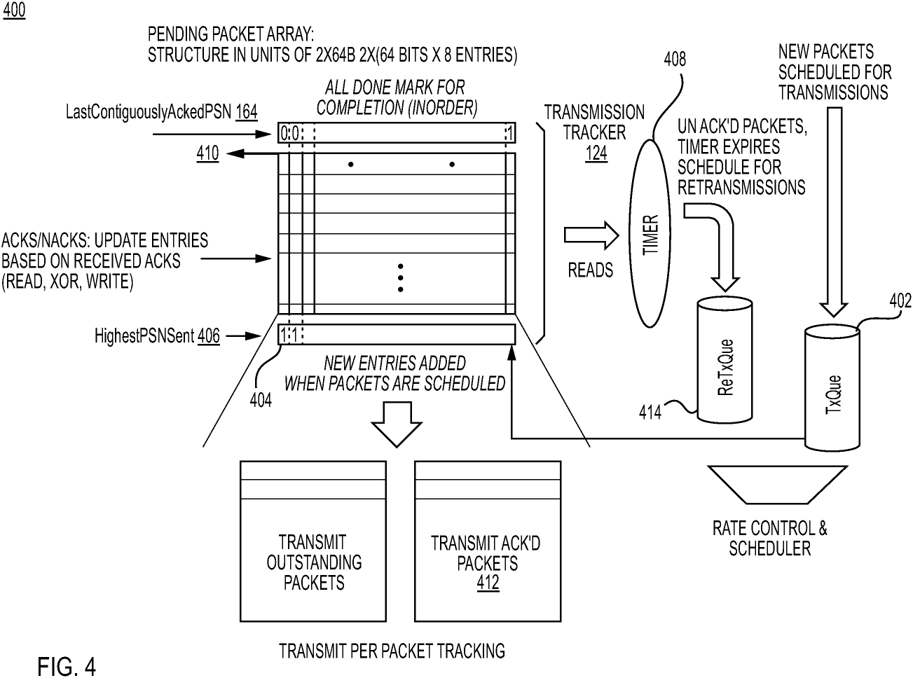

FIG. 4 shows a diagram illustrating interactions 400 between various elements of the transmitter 102 for tracking the transmission of data packets, according to an example. When a new data packet is scheduled for transmission in the transmission queue 402, the packet sequence number (PSN) of the new data packet may be added to the tail 404 of the transmission tracker 124. In an example, the transmission tracker 124 may operate as a first in first out (FIFO) structure wherein data packets corresponding to the packet sequence numbers (PSNs) at the end of the transmission tracker 124 are transmitted. When the acknowledgement packet 160 is received, the LastContiguouslyAckedSeqNumber 164 may be extracted and identified in the transmission tracker 124. The bits in the SelAckBitVector 162 representing the acknowledgement (ACK) (e.g., ‘1’) or a negative acknowledgement (NACK) (e.g., ‘0’) for each received data packet may be serially applied to the packet sequence numbers (PSNs) following the LastContiguouslyAckedSeqNumber 164 until the highestPSNsent 406 may be reached. Each bit of the SelAckBitVector 162 may be read and applied to the corresponding entry of the transmission tracker 124 starting from the first entry 410 after the LastContiguouslyAckedSeqNumber 164. A possibility exists that the same acknowledgement (ACK) may be received multiple times or the same data packet may be acknowledged more than once. In order to track data packets that have been acknowledged at least once, an exclusive OR (XOR) operation may be executed in an update operation between the first entry 410 (i.e., a transmit bit vector array) and the corresponding bit of the SelAckBitVector 162. The update operation for the transmit acknowledged packets table 412 and the SelAckBitVector 162 is shown below:

int index = indexForLastFullyAckedPackets;
for (int I = 0; I < selAckPacket.numOfEntries;i++){
psnTracker[index] =
psnTracker[index]^[selAckPacket.psnTracker[i] & ~
TxAckedSTateTracker[index]);
TxAckedSTateTracker[index] = TxAckedStateTracker[index] |
selAckPacket.psnTracker[i];
Index = (index + 1)%PSN_TRACKER_SIZE;
}

Offset into sequence number space may be calculated based on the LastContiguouslyAckedSeqNumber 164. Each time an acknowledgement (ACK) is received, 64 bytes may be read from the transmission tracker 124 and the above-described operation may be performed. The transmission tracker 124 may be further associated with a timer 408. In case any of the data packets remain unacknowledged so that an acknowledgement (ACK) or a negative acknowledgement (NACK) message is not received by the transmitter 102 at timeout, such data packets may also be added to the retransmission queue 414. In an example, when a contiguous stream of data packets is being transmitted, the transmitter 102 may not wait for the timeout before scheduling retransmissions as the receiver 104 may keep track of data packets received in an out of order manner and may be issuing selective acknowledgements aggressively. In an example, each entry in the transmission queue 402 may include 2 bits and together with the transmission tracker 124, the transmission queue 402 may keep track of scheduled packets, outstanding packets on the wire and acknowledged packets.

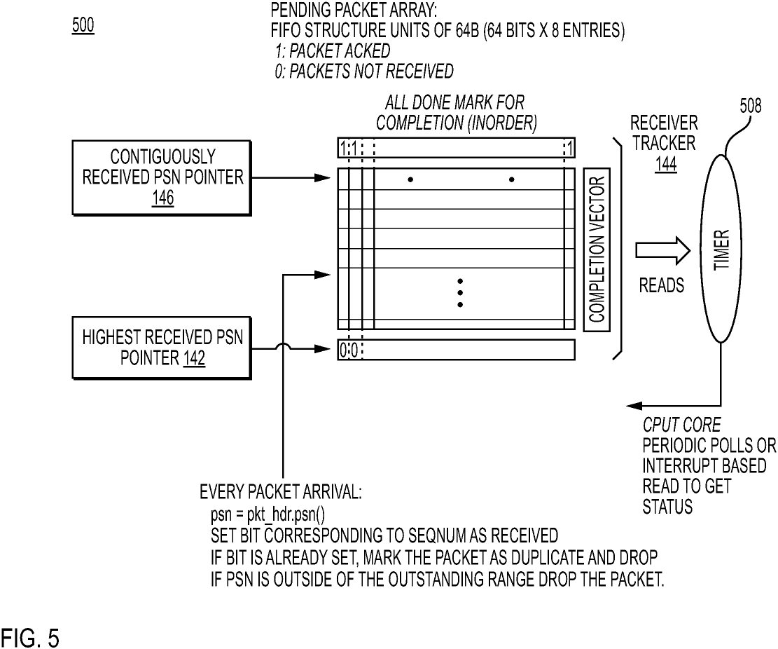

FIG. 5 shows a diagram 500 of the interactions between various elements of the receiver 104 for tracking the reception of data packets, according to an example. The receiver 104 may also maintain a bit-vector based data packet tracking that may be used to generate the corresponding acknowledgements. As the data packets arrive at the receiver 104, the data may be written into the memory (not shown) and the status of the data packets may be tracked in the receiver tracker 144 implemented as a bit vector array. In an example, the receiver tracker 144 may be implemented as a FIFO structure storing the packet sequence numbers (PSNs) of received data packets with 8 entries having 64 bits each. When a data packet is received accurately, the HighestReceivedPSN 206 may be updated in the highest received packet sequence number (PSN) pointer 142 and the bit corresponding to the sequence number in the SelAckBitVector 162 may be set to ‘received’. If the bit is already set, then the data packet may be marked as duplicate and dropped. If the packet sequence number (PSN) is outside the range of the outstanding packets, the data packet may be dropped. The receiver tracker 144 may also maintain the contiguously received packet sequence number (PSN) 208 in the contiguously received packet sequence number (PSN) pointer 146. The receiver tracker 144 may also be associated with a timer 508 so that upon timeout, the lost packets (i.e., data packets that were never received) may be identified. The receiver 104 may send out acknowledgements (ACKs) for data packets that were properly received and negative acknowledgements (NACKs)for improperly received or missing data packets. In an example, the receiver tracker 144 may be read in units of 64 B for formatting the header of the acknowledgement packet 160 to include LastContiguouslyAckedSeqNumber 164 and the SelAckBitVector 162. Updates from the receiver tracker 144 are included in the SelAckBitVector 162 on a first in first out (FIFO) basis and completion updates may be based on contiguous packets received at the tail of the first in first out (FIFO) structure. The scheduling of the acknowledgement packets may be thus triggered based on preset timers, packet arrivals and contiguous packets identified from the receiver tracker 144.

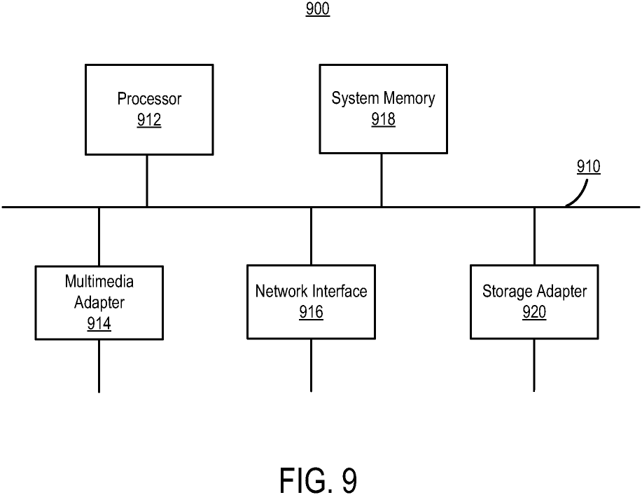

The methods detailed in the flowcharts below are provided by way of an example. There may be a variety of ways to carry out the method described herein. Although the method detailed below are primarily described as being performed by the transmitter 102 or the receiver 104, as shown in FIGS. 1, 2, 4 and 5, or computer system 900 shown and described in FIG. 9 below, the methods described herein may be executed or otherwise performed by other systems, or a combination of systems. Each block shown in the flowcharts described below may further represent one or more processes, methods, or subroutines, and one or more of the blocks may include machine-readable instructions stored on a non-transitory computer-readable medium and executed by a processor or other type of processing circuit to perform one or more operations described herein.

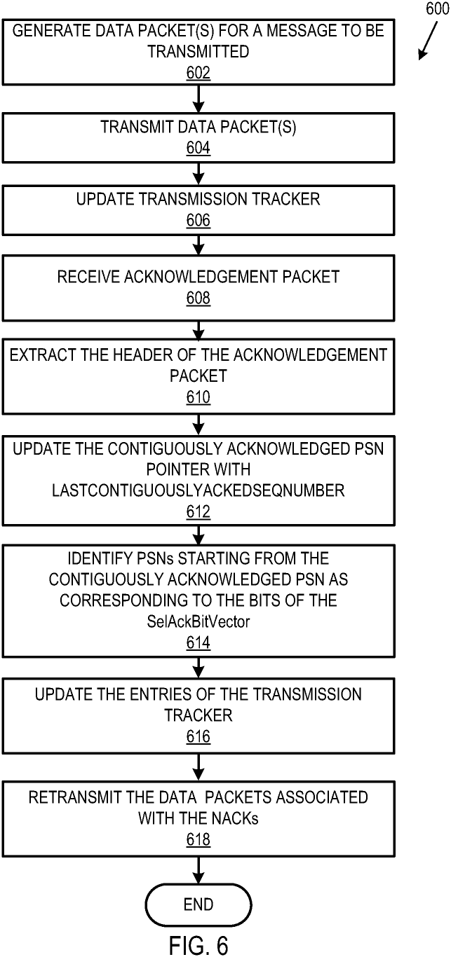

FIG. 6 shows a flowchart 600 of the selective acknowledgement process implemented by the transmitter 102, according to an example. The method begins at 602 wherein the plurality of data packets 150 may be generated by segmenting the message 106 which is to be transmitted to the receiver 104. The plurality of data packets 152, 154,...thus generated may be transmitted at 604 as the segment of data packets 150 to the receiver 104 by the transmitter 102. The transmission tracker 124 may be updated with the transmission information at 606. In particular, the highest scheduled packet sequence number (PSN) pointer 122 may be updated with the packet sequence number (PSN) of the last transmitted data packet from the segment of data packets 150. At 608, the acknowledgement packet 160 may be received in response to the transmitted data packets. At 610, the header values of the acknowledgement packet 160 may be extracted. In an example, the header of the acknowledgement may include, at least the select acknowledgement bit vector (SelAckBitVector 162), a last contiguously acknowledged sequence number (LastContiguouslyAckedSeqNumber) 164, a maximum sequence number (MaxSequenceNumber) 166 and the ChainedAcks 168 flag where necessary. At 612, the contiguously acknowledged packet sequence number (PSN) pointer 126 may be updated with the LastContiguouslyAckedSeqNumber 164 by the transmitter 102. The value of the contiguously acknowledged packet sequence number (PSN) 204 stored in the contiguously acknowledged packet sequence number (PSN) pointer 126 may also be identified as the anchor value in the sequence number space so that the packet sequence numbers (PSNs) starting from the contiguously acknowledged packet sequence number (PSN) 204 until the maximum sequence number 166 may be identified at 614 as corresponding to the bits in the SelAckBitVector 162. At 616, the entries of the transmission tracker 124 may be updated based on the received acknowledgements (ACKs)/negative acknowledgements (NACKs) of the acknowledgement packet 160. In an example, each entry/transmission bit vector of the transmission tracker 124 may correspond to a data packet which may also be represented by a corresponding bit in the SelAckBitVector 162. An update operation including a XOR operation may be executed between each of the entries in the transmission tracker 124 and the corresponding bits of the SelAckBitVector 162 to eliminate duplicate ACKs. Based on the results of the update operation, the data packets that were associated with zero bits may be re-transmitted at 618. In an example, the transmitter 102 may also be associated with the timer 408 so that a subset of the data packets from the segment of data packets 150 that were not acknowledged may be automatically re-transmitted.

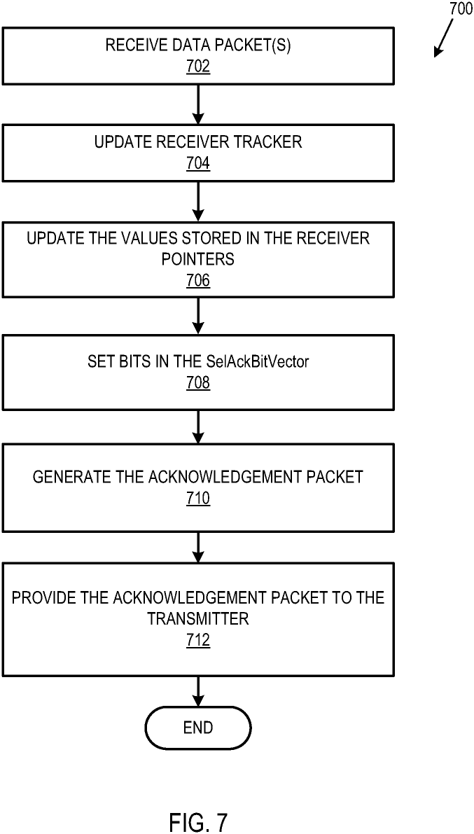

FIG. 7 shows a flowchart 700 of a method of implementing selective acknowledgement of data packets by the receiver 104, according to an example. At 702 the segment of data packets 150 from the transmitter 102 may be received by the receiver 104. As each data packet of the segment of data packets 150 is received, the packet sequence number (PSN) of the received data packets may be updated to the receiver tracker 144 at 704. In an example, the packet sequence number (PSN) of the data packet may be calculated from the LastContiguouslyAckedSeqNumber 164 until the last data packet of the segment of data packets 150 is received or the timer 508 expires depending on whichever event may occur first. Based on the reception of the data packets 152, 154,... from the segment of data packets 150, the two pointers at the receiver 104 including the highest received packet sequence number (PSN) pointer 142 and the contiguously received packet sequence number (PSN) pointer 146 may be updated at 706. The corresponding bits in the SelAckBitVector 162 may be set at 708 based on the values stored in the two receiver pointers. If a data packet is received completely the bit in the SelAckBitVector 162 corresponding to the packet sequence number (PSN) may be set to 1 as an acknowledgement (ACK) and if a data packet is dropped or received incorrectly, the corresponding bit may be set to 0 (NACK). The acknowledgement packet 160 may be generated at 710 to include the SelAckBitVector 162, the LastContiguouslyAckedSeqNumber 164, the MaxSequenceNumber 166 and optionally the ChainedAcks 168. The acknowledgement packet 160 thus generated may be provided to the transmitter 102 at 712.

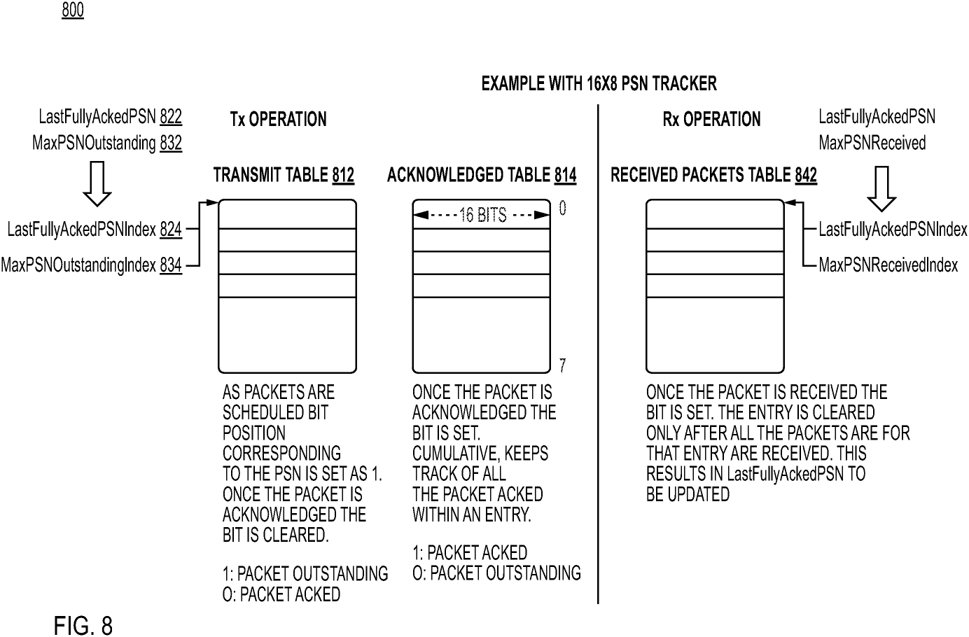

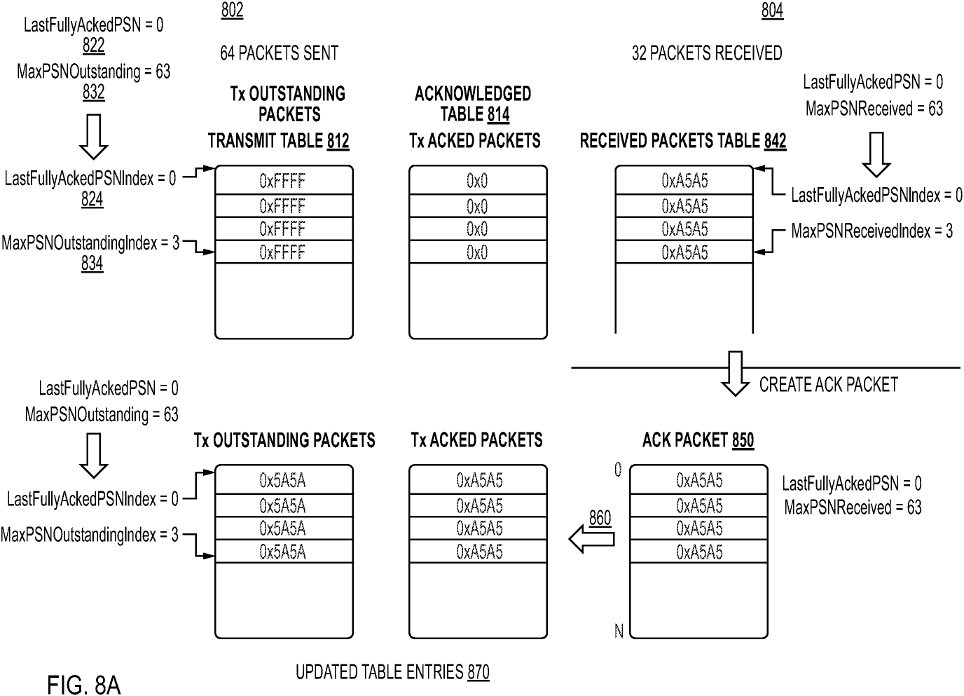

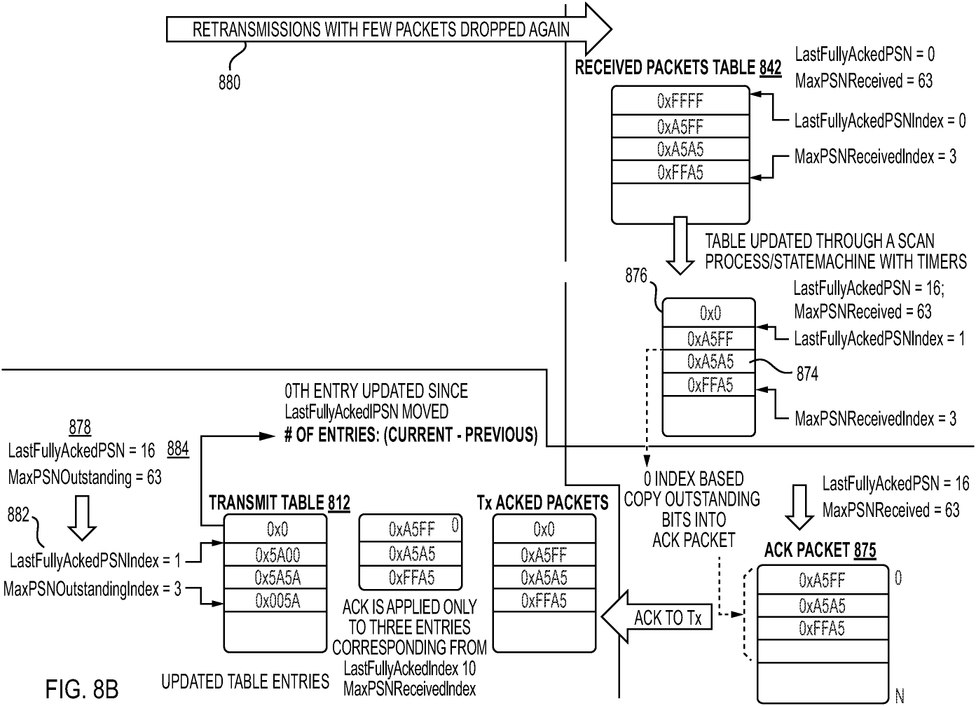

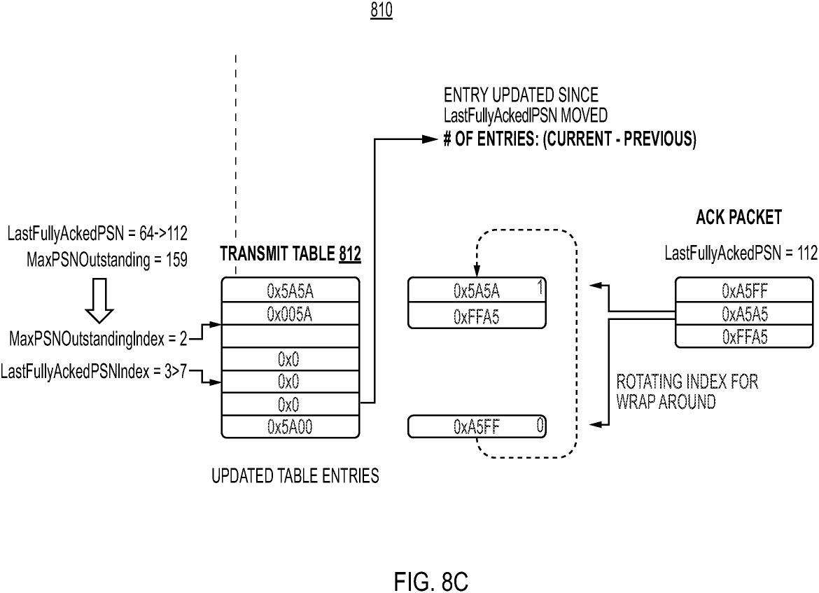

FIGS. 8, 8A, 8B and 8C show the initial states of the various tables and pointers and the state changes that occur in the different tables and pointers during a packet tracking process, according to an example. The example tracking process illustrates the changes in the bits stored in the different tables and the movements of the pointers as the data packets are transmitted, received and acknowledged during a communication procedure. The packet sequence number (PSN) space i.e., the number of possible packet sequence numbers (PSNs) for the data packets flowing through the network 190 may be very large. The selective acknowledgement scheme implemented according to an example may map the large packet sequence number (PSN) space to a much smaller space in the communication network hardware which enables tracking the packet sequence numbers (PSNs) across the network 190. The mappings may include storing the value of the LastFullyAckedPSN 822 to the LastFullyAckedPSNIndex 824 and the MaxPSNOutstanding 832 to the MaxPSNOutstandingIndex 834. In an example, the transmit bit vector arrays of the transmission tracker 124 may form a transmit table 812 and an acknowledged table 814. Each of the transmit table 812 and the acknowledged table 814 may include 8 possible entries wherein each entry may further include a 16-bit representation of a packet sequence number (PSN) so that, 128 data packets can be tracked in this illustration. Accordingly, the segment of data packets 150, in this case, may include a maximum of 128 data packets. It may be appreciated that the tables/the pointer sizes and the number of data packet numbers are provided only for illustration purposes and that other implementations may be possible in real-world communication systems. At the beginning of a data packet transmission, all entries of the tables and the indices are set to zero as no data packets are sent or acknowledged as shown at 800 in FIG. 8. As a data packet is scheduled for transmission, the bit position corresponding to the packet sequence number (PSN) is set as 1 in the Transmit table 812 and when the data packet is acknowledged by the receiver 104, the bit is cleared in the Transmit table 812. Referring to the acknowledged table 814, when a data packet is acknowledged, the bit corresponding to the packet sequence number (PSN) of the data packet is set to 1 whereas the bit remains as 0 if the data packet is outstanding i.e., has not been acknowledged or has received a negative acknowledgement (NACK). Referring to the received packets table 842, once a data packet is received, the bit corresponding to the packet sequence number (PSN) of the data packet is set as 1 and the entry is cleared only after all the data packets for that entry are received. This causes the LastFullyAckedPSN to be updated.

An initial transmit operation is illustrated in state 802 in FIG. 8A, wherein 64 packets are transmitted and no acknowledgements are yet received, therefore the entries in the acknowledged table 814 remain zero. In the transmit table 812, 64 bits may be set with each bit indicating a data packet. The MaxPSNOutstanding 832 (or the highest scheduled packet sequence number (PSN) 202) may be set to 63 and the MaxPSNOutstandingIndex 834 (or the highest scheduled packet sequence number (PSN) pointer 126) may be set to 3 while the LastFullyAckedPSNIndex 824 that stores the packet sequence number (PSN) of the data packet for which the latest acknowledgement (ACK) was received remains unchanged.

Assuming that only 32 data packets were received by the receiver 104 with half of the data packets being dropped, the state 804 shows the status of the indices and tables maintained by receiver 104. Further assuming that the first and the third entries (odd-numbered data packets) in the received packets table 842 are set to 1 indicating accurate receipt of these packets, the LastFullyAckedPSN may therefore be 0 and the MaxPSNReceived (or highest received packet sequence number (PSN) 206) maybe 63 while the MaxPSNReceivedIndex (or highest received packet sequence number (PSN) pointer 142) may be set to 3 as the even-numbered data packets are not received. These values may be used to generate the Ack Packet 850 which may be provided at 860 to the transmitter 102. The updated table entries 870 of the transmit table 812 and the acknowledgement table 814 are obtained using the update operation described herein wherein a value of 1 represents an acknowledged packet while 0 may represent an outstanding packet. Thus, the transmitter 102 may identify the outstanding data packets that need to be re-transmitted based on updated table entries 870.

FIG. 8B illustrates a re-transmission operation, according to an example. The description below pertains to the re-transmission of 32 data packets that were dropped in the transmission described above. Based on the Ack Packet 850, the transmitter 102 identifies the dropped data packets to be re-transmitted. The received packets table 842 may be updated after the re-transmission 880 wherein a few more data packets may be received but some data packets (e.g., 16 data packets) may be dropped yet again. For example, the corresponding first and third entries of the received packets table 842 are different in FIG. 8B as compared to the corresponding entries in the received packets table 842 in FIG. 8A. In the same table, it may be further noted that the data packets pertaining to the first entry 876 are completely received i.e., the receiver 104 has received 16 contiguous data packets. Accordingly, the value of the LastFullyAckedPSN 872 at the receiver 104 may be updated to 16 and the LastFullyAckedPSNIndex may be updated to 1. Again, it may be assumed that some data packets associated with entry 874 remain missing so that the Ack Packet 875 may be generated accordingly. Based on the Ack Packet 875, the transmitter 102 may identify the 16 contiguously received data packets. In this case, the LastFullyAckedPSN 872 at the receiver 104 may be stored in the contiguously received packet sequence number (PSN) pointer 146 as the contiguously received packet sequence number (PSN) 208. Accordingly, the transmitter 102 may also update at 878, the transmit table 812 so that the LastFullyAckedPSN 884 at the transmitter 102 may be set to 16 and the LastFullyAckedPSNIndex 882 may be set to 1. In this case wherein contiguous data packets are received by the receiver 104, the LastFullyAckedPSN 884 may be stored as the contiguously acknowledged packet sequence number (PSN) 204 in the contiguously acknowledged packet sequence number (PSN) pointer 126. The data packets associated with three of the entries of the transmit table 812 remain outstanding as shown by the value of MaxPSNReceivedIndex being set to 3. The transmitter operations may thus continue until all the data packets are received and acknowledged by the receiver 104.

FIG. 8C illustrates a transmission operation 810, according to an example. In the illustrated transmission operation 810, the transmitter pointers may crossover and wrap around the transmit table 812 as the transmit table entries are moved as described above with the transmissions and acknowledgements of different data packets.

FIG. 9 illustrates a block diagram of a computer system 900 for data packet transmission, reception, and acknowledgement, according to an example. The computer system 900 may be part of or any one of the transmitter 102 and the receiver 104 to perform the functions and features described herein. The computer system 900 may include, among other things, an interconnect 910, a processor 912, a multimedia adapter 914, a network interface 916 for the transmission and reception of data packets, a system memory 918, and a storage adapter 920. The system memory 918 may store instructions that may cause the processor 912 to carry out certain tasks such as those outlined in the flowcharts of FIGS. 6 and 7.

It should be appreciated that the processor 912 may be a semiconductor-based microprocessor, a central processing unit (CPU), or may include, one or more programmable general-purpose or special-purpose microprocessors, an application specific integrated circuit (ASIC), a field-programmable gate array (FPGA), digital signal processors (DSPs), programmable controllers, programmable logic device (PLDs), trust platform modules (TPMs), other processing circuits, or a combination of these and/or other suitable hardware devices. The processor 912 may control the overall operation of the computing system 900. In some examples, the processor 912 may accomplish this by executing software or firmware stored in system memory 918 or other data via the storage adapter 920.

In some examples, the system memory 918 may have stored thereon machine-readable instructions (which may also be termed computer-readable instructions) that the processor 912 may execute. The system memory 918 may be an electronic, magnetic, optical, or other physical storage device that contains or stores executable instructions. The system memory 918 may be, for example, Random Access Memory (RAM), an Electrically Erasable Programmable Read-Only Memory (EEPROM), a storage device, an optical disc, and the like. The system memory 918, which may also be referred to as a computer-readable storage medium, maybe a non-transitory machine-readable storage medium, where the term “non-transitory” does not encompass transitory propagating signals.

The interconnect 910 may interconnect various subsystems, elements, and/or components of the computer system 900. As shown, the interconnect 910 may be an abstraction that may represent any one or more separate physical buses, point-to-point connections, or both, connected by appropriate bridges, adapters, or controllers. In some examples, the interconnect 610 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1364 bus, or “firewire,” or other similar interconnection element.

In some examples, the interconnect 910 may allow data communication between the processor 912 and system memory 918. The system memory 918 may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operations such as the interaction with one or more peripheral components.

The multimedia adapter 914 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 916 may provide the computing device with an ability to communicate with a variety of remote devices over a network and may include, for example, an Ethernet adapter, a Fiber Channel adapter, and/or other wired- or wireless-enabled adapter. The network interface 916 may provide a direct or indirect connection from one network element to another, and facilitate communication between various network elements.

The storage adapter 920 may connect to a standard computer-readable medium for storage and/or retrieval of information, such as a fixed disk drive (internal or external).

Many other devices, components, elements, or subsystems (not shown) may be connected in a similar manner to the interconnect 910 or via a network. Conversely, all of the devices shown in FIG. 9 need not be present to practice the present disclosure. The devices and subsystems may be interconnected in different ways from that shown in FIG. 9 Code to implement the present disclosure may be stored in computer-readable storage media such as one or more of system memory 918 or other storage. Code to implement the present disclosure may also be received via one or more interfaces and stored in memory. The operating system provided on computer system 900 may be MS-DOS®, MS-WINDOWS®, OS/2®, OS X®, IOS®, ANDROID®, UNIX®, Linux®, or another operating system.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A system, comprising:
a processor; and
a memory storing instructions, which when executed by the processor, cause the processor to:
transmit a plurality of data packets as a segment of data packets to a receiver, wherein the plurality of data packets of the segment of data packets are identified by corresponding packet sequence numbers (PSNs);
receive an acknowledgement packet from the receiver in response to the segment of data packets, the acknowledgement packet comprising at least a select acknowledgement bit vector, wherein each bit of the select acknowledgement bit vector represents a corresponding data packet from the segment of data packets, and a value of each bit of the select acknowledgement bit vector indicates one of an acknowledgement (ACK) of the corresponding data packet by the receiver and a negative acknowledgement (NACK) of the corresponding data packet by the receiver, and wherein the acknowledgement packet further comprises a last contiguously acknowledged packet sequence number (PSN) that corresponds to an anchor value in a sequence number space from where the select acknowledgement bit vector is applicable;
identify one or more dropped data packets of the segment of data packets based at least in part on the select acknowledgement bit vector; and
transmit at least one of the identified one or more dropped data packets to the receiver.

2. (canceled)

3. The system of claim 1, wherein the acknowledgement packet further comprises a maximum sequence number that represents a number of packet sequence numbers (PSNs) being acknowledged in the acknowledgement packet.

4. The system of claim 1, wherein the processor is further to:
maintain the packet sequence numbers (PSNs) of the plurality of data packets of the segment of data packets scheduled for transmission to the receiver and the packet sequence numbers (PSNs) of one or more data packets acknowledged by the receiver in a transmission tracker including one or more transmit bit vector arrays.

5. The system of claim 4, wherein to retransmit the one or more dropped data packets, the processor is to:
execute an exclusive OR (XOR) operation between the transmit bit vector arrays and the select acknowledgement bit vector;
determine, based on the exclusive OR (XOR) operation, if each data packet of the segment of data packets is received by the receiver or included in the one or more dropped data packets; and
identify each data packet of the segment of data packets associated with a zero bit upon execution of the exclusive OR (XOR) operation as one of the one or more dropped data packets.

6. The system of claim 4, wherein the processor is further to:
update the transmission tracker with newer packet sequence numbers (PSNs) of newer data packets added to a transmission queue.

7. The system of claim 4, wherein the processor is further to:
reset the one or more transmit bit vector arrays upon expiration of a preset timer.

8. The system of claim 1, wherein the processor is further to:
maintain the packet sequence number (PSN) of a latest data packet of the segment of data packets scheduled for transmission within a highest scheduled packet sequence number (PSN) pointer.

9. The system of claim 8, wherein the processor is further to:
store in a contiguously acknowledged packet sequence number (PSN) pointer, a packet sequence number (PSN) of a latest data packet of a sequence of data packets that were acknowledged by the receiver as contiguously received from the segment of data packets and require no retransmission.

10. The system of claim 9, wherein the processor is further to:
identify one or more data packets of the segment of data packets with packet sequence numbers (PSNs) associated with a difference between the highest scheduled packet sequence number (PSN) pointer and the contiguously acknowledged packet sequence number (PSN) pointer as data packets in flight from the system to the receiver.

11. A system comprising:
a processor; and
a memory storing instructions, which when executed by the processor, cause the processor to:
receive one or more data packets transmitted as a segment of data packets, wherein the one or more data packets in the segment of data packets are identified by corresponding packet sequence numbers (PSNs);
generate an acknowledgement packet for the segment of data packets by including at least a select acknowledgement bit vector, wherein each bit of the select acknowledgement bit vector represents a corresponding data packet of the segment of data packets;
set a value of each bit of the select acknowledgement bit vector to be indicative of an acknowledgement (ACK) or a negative acknowledgement (NACK) of the corresponding data packet; and
include a last contiguously acknowledged sequence number as an anchor value from where the select acknowledgement bit vector is applicable in the acknowledgement packet and a max sequence number that represents a number of the packet sequence numbers (PSNs) being acknowledged in the acknowledgement packet.

12. The system of claim 11, wherein the processor is further to:
extract the packet sequence numbers (PSNs) of the one or more data packets from headers of the one or more data packets.

13. The system of claim 11, wherein the processor is further to:
maintain in a receiver tracker including one or more receive bit vector arrays, the corresponding packet sequence numbers (PSNs) of acknowledged data packets from the segment of data packets.

14. The system of claim 11, wherein to set the value of each bit of the select acknowledgement bit vector for the acknowledgement (ACK) or the negative acknowledgement (NACK), the processor is to:
set a value of each bit of the select acknowledgement bit vector to 1 for the acknowledgement (ACK) and set a value of each bit of the select acknowledgement bit vector to 0 for the negative acknowledgement (NACK).

15. The system of claim 11, wherein the processor is further to:
maintain within a highest received packet sequence number (PSN) pointer, the packet sequence number (PSN) of a last data packet successfully received from the segment of data packets.

16. The system of claim 15, wherein the processor is further to:
maintain within a contiguously received packet sequence number (PSN) pointer, the packet sequence number (PSN) of a last data packet of a sequence of data packets contiguously received from the segment of data packets.

17. A method comprising:
accessing a contiguously acknowledged packet sequence number (PSN) of a last data packet in a data packet sequence received contiguously without requiring re-transmission from a plurality of data packets transmitted as a segment of data packets, wherein each data packet of the segment of data packets is represented by a corresponding packet sequence number (PSN);
accessing a highest scheduled packet sequence number (PSN) of a last data packet scheduled for transmission from the segment of data packets;
scheduling a subset of data packets from the segment of data packets for transmission, wherein the corresponding packet sequence numbers (PSNs) of the subset of data packets lie between the contiguously acknowledged packet sequence number (PSN) and the highest scheduled packet sequence number (PSN);
transmitting the subset of data packets to a receiver; and
receiving an acknowledgement packet in response to the transmission of the subset of data packets to the receiver, the acknowledgement packet includes at least a select acknowledgement bit vector wherein:
each bit of the select acknowledgement bit vector represents a corresponding data packet of the subset of data packets, and
a value of each bit of the select acknowledgement bit vector indicates an acknowledgement (ACK) or a negative acknowledgement (NACK) of receipt of the corresponding data packet by the receiver.

18. The method of claim 17, further comprising:
executing an exclusive OR (XOR) operation between one or more transmit bit vector arrays storing at least the packet sequence numbers (PSNs) of the subset of data packets and the select acknowledgement bit vector;
identifying one or more dropped data packets of the subset of data packets based on the exclusive OR (XOR) operation; and
transmitting the one or more dropped data packets to the receiver.

19. The method of claim 17, further comprising:
resetting a highest scheduled packet sequence number (PSN) pointer to a next data packet sequence number (PSN) scheduled for transmission from the segment of data packets; and
updating the contiguously acknowledged packet sequence number (PSN) pointer to a contiguously received packet sequence number (PSN) value obtained from the receiver.

20. A non-transitory computer-readable medium having instructions, which when executed by a processor, cause the processor to perform the method of claim 17.
